(19) United States
(12) Patent Application Publication
(10) Pub. No.: US 2016/0246523 A1
(43) Pub. Date: Aug. 25, 2016

(54) SYSTEM FOR PROVIDING VIRTUAL BLOCK DEVICE

(71) Applicant: Electronics and Telecommunications Research Institute, Daejeon (KR)

(72) Inventors: Byoung Seob KIM, Sejong-si (KR); Hyun Hwa CHOI, Daejeon (KR); Seung Jo BAE, Daejeon (KR)

(21) Appl. No.: 14/954,167

(22) Filed: Nov. 30, 2015

(30) Foreign Application Priority Data
Feb. 25, 2015 (KR) 10-2015-0026653

(51) Int. Cl. G06F 3/06; G06F 12/12

(52) U.S. Cl. CPC G06F 3/0619; G06F 12/122; G06F 3/065; G06F 3/0685; G06F 3/0653; G06F 3/064; G06F 2212/69

(57) ABSTRACT

Provided herein is a system for providing a virtual block device, which includes a logical block device configured to transmit and receive data to and from an external computer and to have logical block IDs, and a physical block device configured to include a cache area and a storage area for storing at least a part of the data and to have physical block IDs, wherein the cache area comprises a first memory cluster having first memory IDs, the storage area comprises a second memory cluster having second memory IDs and a third memory cluster having third memory IDs, and the physical block IDs include the first to third memory IDs. The system can simultaneously cope with both an application requiring a large capacity and an application requiring a short access time, using a single virtual block device provision system in which various storage devices are included.

### CROSS-REFERENCE TO RELATED APPLICATION

The present application claims priority to and the benefit of Korean patent application number 10-2015-0026653 filed on Feb. 25, 2015, the entire disclosure of which is incorporated herein in its entirety by reference.

### BACKGROUND

1. Field of Invention

Various embodiments of the present disclosure relate to a system for providing a virtual block device.

2. Description of Related Art

Recently, there are attempts to use a block device as a sub-storage device. Such attempts may require a short access time in some cases or require a large capacity in other cases, depending on the applications thereof.

Representative storage devices that are currently used include a Hard Disk Drive (HDD) and a Solid State Drive (SSD). HDD provides a large capacity compared to the price thereof, but is disadvantageous in that an access time (data access speed) is lengthened. In contrast, SSD provides a short access time, but is disadvantageous in that the price thereof is high compared to the capacity thereof. Therefore, a problem arises in that a virtual block device provision system, which is provided to an application requiring a large capacity, and a virtual block device provision system, which is provided to an application requiring a short access time, must be separately used.

### SUMMARY

Various embodiments of the present disclosure are directed to a system for providing a virtual block device, which can simultaneously cope with both an application requiring a large capacity and an application requiring a short access time by using only a single virtual block device provision system in which all of various types of storage devices are included.

Furthermore, various embodiments of the present disclosure are directed to a system for providing a virtual block device, which shifts data, stored in a storage device having a relatively short access time, to a storage device having a relatively long access time, based on information about the frequency of use of blocks, so that only data that is frequently used is stored in the storage device having a relatively short access time, thus shortening the access time.

One embodiment of the present disclosure provides a system for providing a virtual block device, including a logical block device configured to transmit and receive data to and from an external computer and to have logical block IDs, and a physical block device configured to include a cache area and a storage area for storing at least a part of the data and to have physical block IDs, wherein the cache area includes a first memory cluster having first memory IDs, the storage area includes a second memory cluster having second memory IDs and a third memory cluster having third memory IDs, and the physical block IDs include the first to third memory IDs.

In an embodiment, the first memory cluster may include first memories from multiple computers, the second memory cluster may include second memories from the multiple computers, and the third memory cluster may include third memories from the multiple computers.

In an embodiment, the system may further include a duplication unit configured to duplicatively write data, provided in response to a write command from the external computer, both in the cache area and in the storage area, and a mapping information storage unit configured to store information about mapping between the logical block IDs and the physical block IDs, wherein the duplication unit is configured to, after writing the data provided in response to the write command, update the mapping information so that the writing is reflected in the mapping information.

In an embodiment, the system may further include a selection unit, wherein when there is data requested in response to a read command from the external computer, the selection unit receives, from the mapping information storage unit, a physical block ID that is mapped to a logical block ID corresponding to the data requested in response to the read command, and wherein the selection unit provides data, stored in an area corresponding to the mapped physical block ID, to the logical block device.

In an embodiment, when the duplication unit duplicatively writes the data provided in response to the write command, a logical block ID corresponding to the data provided in response to the write command may be mapped not only to a first memory ID, but also to one of second and third memory IDs, and the selection unit may provide the logical block device not only with data stored in an area corresponding to the first memory ID mapped to the corresponding logical block ID, but also with data stored in an area corresponding to the second or third memory ID mapped to the corresponding logical block ID.

In an embodiment, a source of the data, along with the data, may be further provided in response to the write command from the external computer, and the duplication unit may determine whether to write the data provided in response to the write command to the second memory cluster or to the third memory cluster, based on the source.

In an embodiment, the system may further include a monitoring unit configured to generate information about frequency of usage of blocks by monitoring logical block IDs that are used, a usage frequency storage unit configured to store the block usage frequency information, and a read performance adjustment module configured to shift at least a part of data stored in an a-th memory cluster (where ‘a’ is an integer ranging from 1 to 3) to a b-th memory cluster (where ‘b’ is an integer ranging from 1 to 3 and differing from ‘a’), based on the block usage frequency information.

In an embodiment, the second memory cluster may have an access time longer than that of the first memory cluster and shorter than that of the third memory cluster, and the second memory cluster may include a Solid State Drive (SSD).

In an embodiment, the block usage frequency information may include a Least Recently Used (LRU) list, and the read performance adjustment module may be configured to shift at least a part of data stored in areas corresponding to second memory IDs that are mapped to logical block IDs, which are included in the LRU list, to the third memory cluster, and shift a part of data stored in areas corresponding to second memory IDs that are mapped to logical block IDs, which are not included in the LRU list, to the first memory cluster.

In an embodiment, the external computer may be capable of transmitting and receiving data to and from at least one of a media stream server, a File Transfer Protocol (FTP) server, a Database Management System (DBMS) server, and a Virtual Machine File System (VMFS) server.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a block diagram showing a system for providing a virtual block device according to an embodiment of the present disclosure;

FIG. 2 is a diagram showing the physical block device of the system for providing a virtual block device, shown in FIG. 1;

FIG. 3 is a diagram showing IDs and pieces of information used by the system for providing a virtual block device, shown in FIG. 1;

FIG. 4 is a diagram showing an external computer for transmitting and receiving data to and from the system for providing a virtual block device, shown in FIG. 1, and servers capable of transmitting and receiving data to and from the external computer.

### DETAILED DESCRIPTION

Hereinafter, embodiments will be described in greater detail with reference to the accompanying drawings. Reference now should be made to the drawings, in which the same reference numerals are used throughout the different drawings to designate the same or similar components. In the following description of the present disclosure, detailed descriptions of known functions and configurations which are deemed to make the gist of the present disclosure obscure will be omitted. Further, the names of components to be used in the following description may be selected in consideration of the easy description of the specification, and may be different from the names of the parts of actual products.

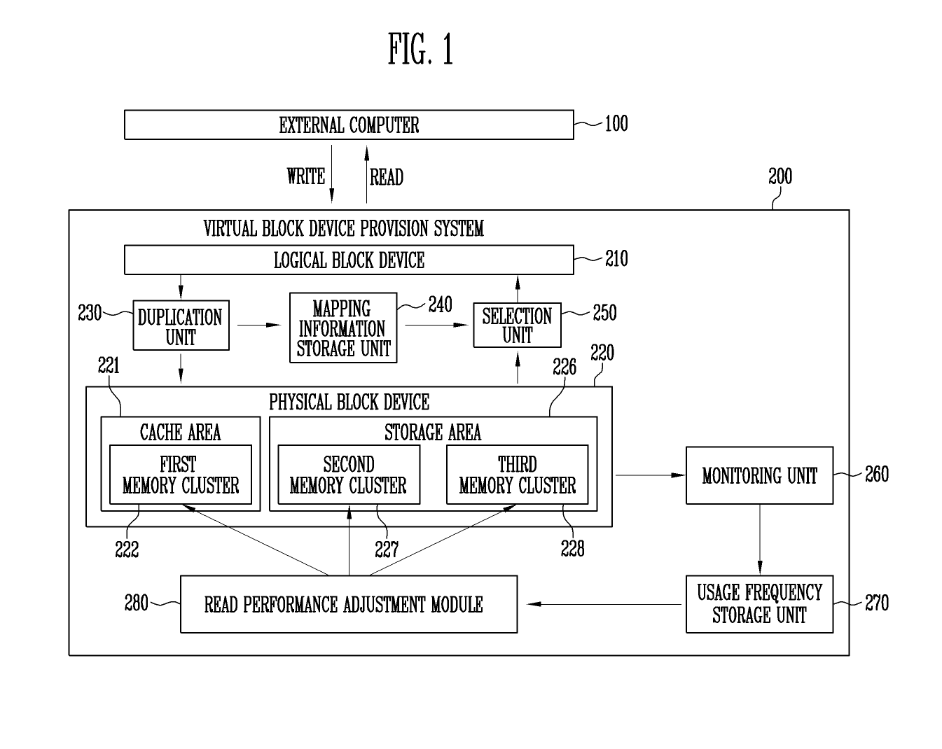

FIG. 1 is a block diagram showing a system for providing a virtual block device according to an embodiment of the present disclosure. Referring to FIG. 1, a system 200 for providing a virtual block device (hereinafter also referred to as a “virtual block device provision system”) includes a logical block device 210, a physical block device 220, a duplication unit 230, a mapping information storage unit 240, a selection unit 250, a monitoring unit 260, a usage frequency storage unit 270, and a read performance adjustment module 280.

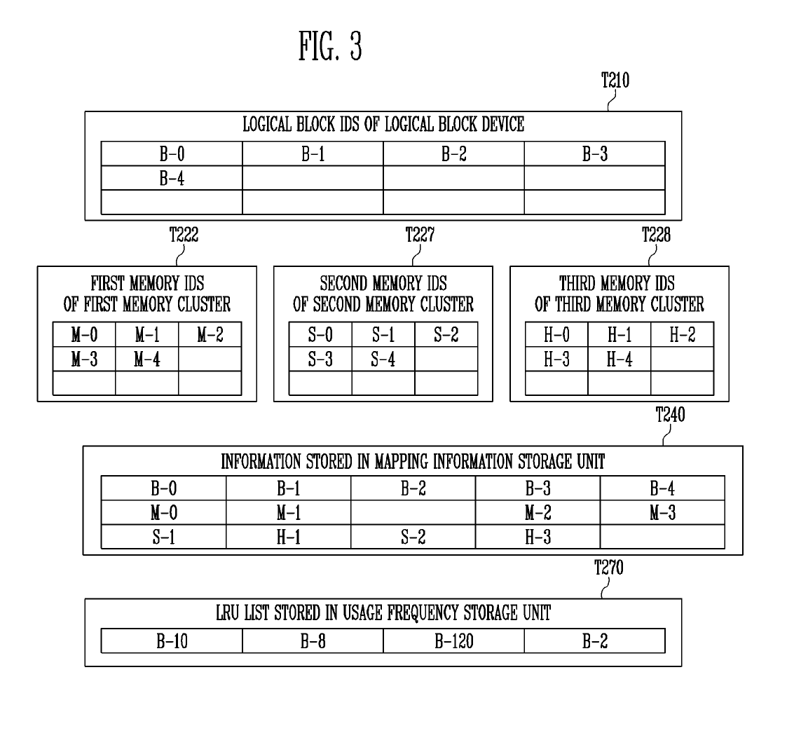

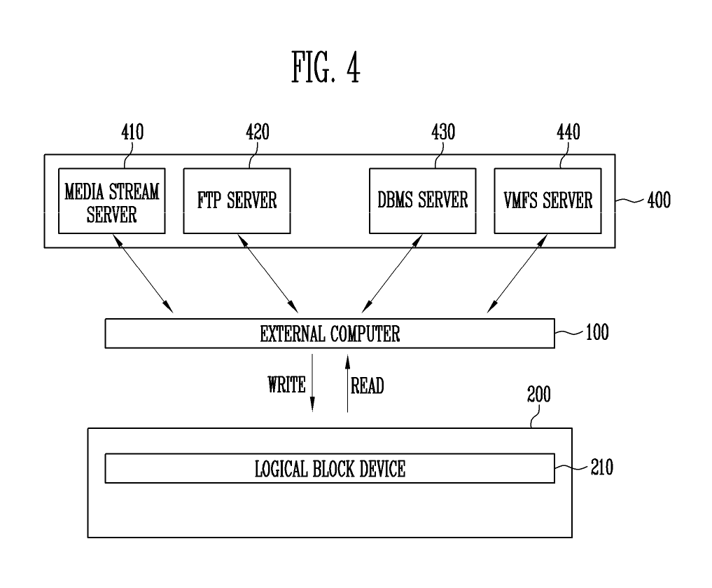

The logical block device 210 transmits and receives data to and from an external computer 100 and has logical block IDs. The logical block IDs will be described in detail later with reference to FIG. 3. Data is provided in response to a write command (WRITE) from the external computer 100, and data is requested in response to a read command (READ) from the external computer 100. In the case of the write command, the source of data, as well as the data, may be further provided. The source of the data will be described in detail later with reference to FIG. 4.

The physical block device 220 includes a cache area 221 and a storage area 226. At least a part of data provided in response to the write command from the external computer 100 is stored in each of the cache area 221 and the storage area 226. The cache area 221 includes a first memory cluster 222, which has first memory IDs. The storage area 226 includes a second memory cluster 227 and a third memory cluster 228, wherein the second memory cluster 227 has second memory IDs and the third memory cluster 228 has third memory IDs. Each of the first memory IDs corresponds to a partial area of the first memory cluster 222, each of the second memory IDs corresponds to a partial area of the second memory cluster 227, and each of the third memory IDs corresponds to a partial area of the third memory cluster 228. Data may be stored in partial areas of the first to third memory clusters 222, 227, and 228. The physical block device 220 has physical block IDs, which include the first to third memory IDs. The logical block IDs are mapped to the first to third memory IDs. Information about mapping between the first to third memory IDs, the logical block IDs, and the physical block IDs will be described in detail later with reference to FIG. 3. The first memory cluster 222 may include at least one memory (Dynamic Random Access Memory (DRAM), Static RAM (SRAM), etc.). The second memory cluster 227 may include at least one Solid State Drive (SSD), and the third memory cluster 228 may include at least one Hard Disk Drive (HDD). In this case, the access time of the second memory cluster 227 may be longer than that of the first memory cluster 222 and may be shorter than that of the third memory cluster 228.

The duplication unit 230 may duplicatively write the data provided in response to the write command from the external computer 100 both to the cache area 221 and to the storage area 226 of the physical block device 220. Of course, the data may be written only to one of the cache area 221 and the storage area 226. When the duplication unit 230 writes data to the storage area 226, it may be determined whether to write the data to the second memory cluster 227 or to the third memory cluster 228, based on the source of the data provided in response to the write command. After writing the data, the duplication unit 230 updates the mapping information so that the writing is reflected in the mapping information.

The mapping information storage unit 240 stores the mapping information. When the duplication unit 230 duplicatively writes the data provided in response to the write command both to the cache area 221 and to the storage area 226 of the physical block device 220, a logical block ID corresponding to the data provided in response to the write command is mapped to a first memory ID. Simultaneously, the logical block ID is also mapped to one of the second and third memory IDs. If the duplication unit 230 writes the data provided in response to the write command to any one of the first to third memory clusters 222, 227, and 228, the logical block ID corresponding to the data provided in response to the write command is mapped to only one of the first to third memory IDs. When there is data requested in response to a read command from the external computer 100, the mapping information storage unit 240 searches for an area of the first to third memory clusters 222, 227, and 228 corresponding to the first to third memory IDs that are mapped to the logical block ID corresponding to the data requested in response to the read command, and transmits data stored in the found area to the outside of the system.

When there is data requested in response to the read command from the external computer 100, the selection unit 250 receives a mapped physical block ID from the mapping information storage unit 240. The selection unit 250 provides data, which is stored in an area corresponding to the mapped physical block ID, to the logical block device 210. If the duplication unit 230 duplicatively writes the data provided in response to the write command both to the cache area 221 and to the storage area 226, a logical block ID corresponding to the data provided in response to the write command is also mapped to one of the second and third memory IDs, as well as the first memory ID. In this case, the selection unit 250 may also provide the logical block device 210 with data stored in an area corresponding to the second or third memory ID that is mapped to the logical block ID corresponding to the data requested in response to the read command, as well as data stored in an area corresponding to the first memory ID that is mapped to a logical block ID corresponding to the data requested in response to the read command.

The monitoring unit 260 generates information about the frequency of usage of blocks (block usage frequency information) by monitoring logical block IDs that are used. The block usage frequency information may include information about the number of times each block was used for a predetermined period of time, the recently used time of each block, etc. However, for the convenience of description, it is assumed that the block usage frequency information includes only information about the recently used time of each block. In this case, the block usage frequency information may include Least Recently Used (LRU) list (information).

The usage frequency storage unit 270 stores the block usage frequency information.

The read performance adjustment module 280 may shift at least a part of data stored in an a-th memory cluster (where ‘a’ is an integer ranging from 1 to 3) to a b-th memory cluster (where ‘b’ is an integer ranging from 1 to 3 and differing from ‘a’), based on the block usage frequency information. The logical block IDs included in the LRU list may be less frequently used, thus not influencing the overall access time of the system 200 for providing a virtual block device. When the second memory cluster 227 is an SSD, the capacity thereof may be small because the SSD is expensive compared to the capacity thereof. The read performance adjustment module 280 shifts at least a part of data stored in areas corresponding to the second memory IDs that are mapped to the logical block IDs, which are included in the LRU list, to the third memory cluster 228. Also, the read performance adjustment module 280 shifts at least a part of data stored in the areas corresponding to second memory IDs that are mapped to the logical block IDs, which are not included in the LRU list, to the first memory cluster 222. When the data stored in the second memory cluster 227 is shifted based on the LRU list in this way, the capacity of the second memory cluster 227 may be efficiently used.

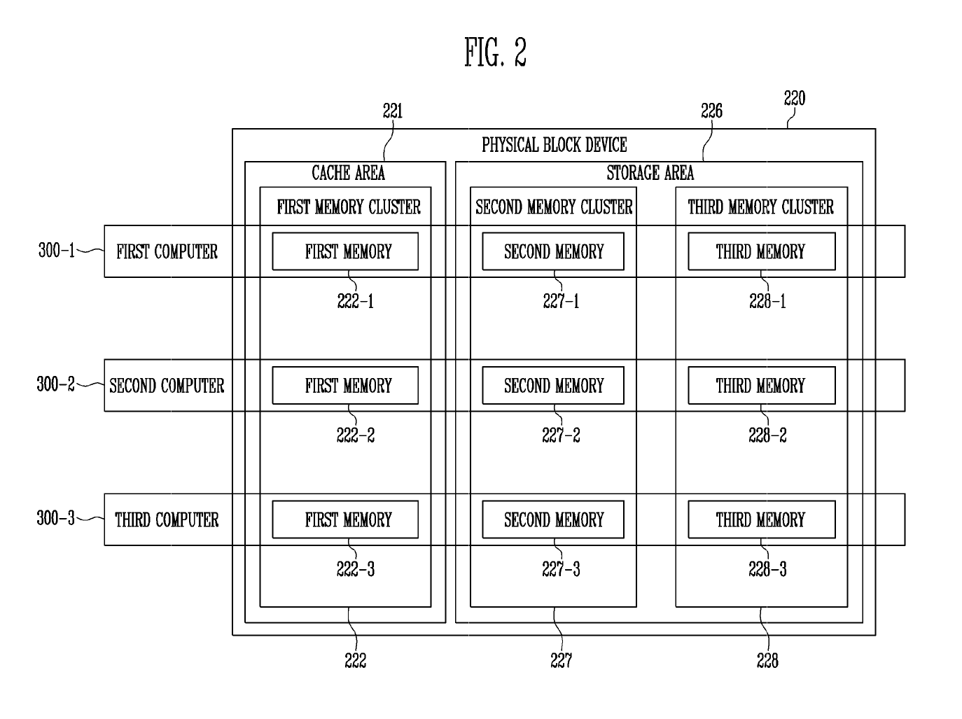

FIG. 2 is a diagram showing the physical block device of the virtual block device provision system of FIG. 1. Below, the physical block device 220 will be described with reference to FIGS. 1 and 2.

The first memory cluster 222 in the cache area 221 includes a first memory 222-1 from a first computer 300-1, a first memory 222-2 from a second computer 300-2, and a first memory 222-3 from a third computer 300-3. That is, the first memory cluster 222 may include the first memories 222-1, 222-2, and 222-3 from multiple computers 300-1, 300-2, and 300-3 (hereinafter referred to as ‘300’). The second memory cluster 227 includes second memories 227-1, 227-2, and 227-3 from the multiple computers 300, and the third memory cluster 228 also includes third memories 228-1, 228-2, and 228-3 from the multiple computers 300. That is, the capacity of the cache area 221 and the storage area 226 may be easily extended by adding disks (or computers) via clustering. The cache area 221, which is an area used by the internal configuration of the system, may be used to shorten the access time of a user block or to solve a load when the load occurs in the user block. Here, each of the first memories 222-1, 222-2, and 222-3 may be a memory (DRAM, SRAM, or the like), each of the second memories 227-1, 227-2, and 227-3 may be an SSD, and each of the third memories 228-1, 228-2, and 228-3 may be an HDD. In this case, the access time of the second memory cluster 227 is longer than that of the first memory cluster 222, and is shorter than that of the third memory cluster 228.

FIG. 3 is a diagram showing IDs and pieces of information used by the virtual block device provision system of FIG. 1. Below, the IDs and pieces of information will be described with reference to FIGS. 1 to 3.

A table T210 is a table required to describe the logical block IDs of the logical block device 210, a table T222 is a table required to describe the first memory IDs of the first memory cluster 222, a table T227 is a table required to describe the second memory IDs of the second memory cluster 227, and a table T228 is a table required to describe the third memory IDs of the third memory cluster 228. The logical block device 210 has logical block IDs (B-0, B-1, B-2, B-3, etc.), the first memory cluster 222 has first memory IDs (M-0, M-1, M-2, M-3, etc.), the second memory cluster 227 has second memory IDs (S-0, S-1, S-2, S-3, etc.), and the third memory cluster 228 has third memory IDs (H-0, H-1, H-2, H-3, etc.).

A table T240 is a table for describing mapping information stored in the mapping information storage unit 240. The logical block IDs (B-0, B-1, B-2, B-3, etc.) are mapped to the physical block IDs (M-0, M-1, M-2, M-3, S-0, S-1, S-2, S-3, H-0, H-1, H-2, H-3, etc.). When data provided in response to a write command from the external computer 100 is duplicatively written both to the cache area 221 and to the storage area 226, the corresponding logical block ID is mapped not only to the first memory ID, but also to one of the second and third memory IDs. For example, the logical block ID (B-0) is mapped to the first memory ID(M-0) and the second memory ID(S-1), the logical block ID(B-1) is mapped to the first memory ID(M-1) and the third memory ID(H-1), and the logical block ID(B-3) is mapped to the first memory ID(M-2) and the third memory ID(H-3). Alternatively, when data provided in response to a write command from the external computer 100 is written to only one of the cache area 221 and the storage area 226, the corresponding logical block ID is mapped to only one of the first to third memory IDs. For example, the logical block ID(B-2) is mapped only to the second memory ID(S-2), and the logical block ID(B-4) is mapped only to the first memory ID(M-3).

A table T270 is a table for describing an LRU list stored in the usage frequency storage unit 270. In the LRU list, the logical block IDs (B-10, B-8, B-120, and B-2) are stored. It may be determined that the logical block IDs stored in the LRU list are logical block IDs corresponding to recently not-used data. Data stored in the areas corresponding to second memory IDs mapped to the logical block IDs stored in the LRU list may be shifted to the third memory cluster 228 by the read performance adjustment module 280. Therefore, data stored in the area corresponding to the second memory ID(S-2) mapped to the logical block ID(B-2) may be shifted to the third memory cluster 228, and the third memory ID (e.g. H-4), instead of the second memory ID(S-2), may be mapped to the logical block ID(B-2). Unlike the table T270 shown in FIG. 3, if B-2 is not present in the LRU list, data stored in an area corresponding to the second memory ID(S-2) mapped to the logical block ID (B-2) may be shifted to the first memory cluster 222, and the first memory ID (e.g. M-4), instead of the second memory ID(S-2), may be mapped to the logical block ID(B-2).

FIG. 4 is a diagram showing an external computer for transmitting and receiving data to and from the virtual block device provision system of FIG. 1, and servers capable of transmitting and receiving data to and from the external computer. Below, a description will be made with reference to FIGS. 1 and 4.

The external computer 100 is capable of transmitting and receiving data to and from various servers 400. When a data write request is received from the servers 400, the external computer 100 receives data and provides the data to the logical block device 210 in response to a write command. In this case, the source of data, as well as the data, may be further provided in response to the write command. For example, such source data may be further provided in such a way that source data of 1 is provided in the case of data from a media stream server 410, source data of 2 is provided in the case of data from a File Transfer Protocol (FTP) server 420, source data of 3 is provided in the case of data from a Database Management System (DBMS) server 430, and source data of 4 is provided in the case of data from a Virtual Machine File System (VMFS) server 440. The logical block device 210, having received the source data, may determine the source of data provided in response to the write command. Data provided from a server requiring a short access time (e.g. the media stream server 410) may be stored in the second memory cluster 227 of the storage area 226. Further, data provided from a server requiring a large capacity (e.g. the FTP server 420) may be stored in the third memory cluster 228 of the storage area 226. In this way, since data is stored based on the source thereof, it is possible to simultaneously cope with both an application requiring a large capacity and an application requiring a short access time by utilizing only a single virtual block device provision system. Of course, data stored in the second memory cluster 227 may be shifted to the first memory cluster 222 or the third memory cluster 228 based on block usage frequency information.

A system for providing a virtual block device according to an embodiment of the present disclosure can simultaneously cope with both an application requiring a large capacity and an application requiring a short access time by using only a single virtual block device provision system in which all of various types of storage devices are included.

Further, a system for providing a virtual block device according to an embodiment of the present disclosure shifts data, stored in a storage device having a relatively short access time, to a storage device having a relatively long access time, based on information about the frequency of use of blocks, so that only data that is frequently used is stored in the storage device having a relatively short access time, thus shortening the access time.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A system for providing a virtual block device, comprising:
a logical block device configured to transmit and receive data to and from an external computer and to have logical block IDs; and
a physical block device configured to include a cache area and a storage area for storing at least a part of the data and to have physical block IDs, wherein the cache area comprises a first memory cluster having first memory IDs,
wherein the storage area comprises a second memory cluster having second memory IDs and a third memory cluster having third memory IDs, and
wherein the physical block IDs include the first to third memory IDs.

2. The system of claim 1, wherein:
the first memory cluster comprises first memories from multiple computers,
the second memory cluster comprises second memories from the multiple computers, and
the third memory cluster comprises third memories from the multiple computers.

3. The system of claim 1, further comprising:
a duplication unit configured to duplicatively write data, provided in response to a write command from the external computer, both in the cache area and in the storage area; and
a mapping information storage unit configured to store information about mapping between the logical block IDs and the physical block IDs,
wherein the duplication unit is configured to, after writing the data provided in response to the write command, update the mapping information so that the writing is reflected in the mapping information.

4. The system of claim 3, further comprising a selection unit,
wherein when there is data requested in response to a read command from the external computer, the selection unit receives, from the mapping information storage unit, a physical block ID that is mapped to a logical block ID corresponding to the data requested in response to the read command, and
wherein the selection unit provides data, stored in an area corresponding to the mapped physical block ID, to the logical block device.

5. The system of claim 4, wherein:
when the duplication unit duplicatively writes the data provided in response to the write command, a logical block ID corresponding to the data provided in response to the write command is mapped not only to a first memory ID, but also to one of second and third memory IDs, and
the selection unit provides the logical block device not only with data stored in an area corresponding to the first memory ID mapped to the corresponding logical block ID, but also with data stored in an area corresponding to the second or third memory ID mapped to the corresponding logical block ID.

6. The system of claim 4, wherein:
a source of the data, along with the data, is further provided in response to the write command from the external computer, and
the duplication unit determines whether to write the data provided in response to the write command to the second memory cluster or to the third memory cluster, based on the source.

7. The system of claim 1, further comprising:
a monitoring unit configured to generate information about frequency of usage of blocks by monitoring logical block IDs that are used;
a usage frequency storage unit configured to store the block usage frequency information; and
a read performance adjustment module configured to shift at least a part of data stored in an a-th memory cluster (where ‘a’ is an integer ranging from 1 to 3) to a b-th memory cluster (where ‘b’ is an integer ranging from 1 to 3 and differing from ‘a’), based on the block usage frequency information.

8. The system of claim 7, wherein:
the second memory cluster has an access time longer than that of the first memory cluster and shorter than that of the third memory cluster, and
the second memory cluster comprises a Solid State Drive (SSD).

9. The system of claim 8, wherein:
the block usage frequency information comprises a Least Recently Used (LRU) list, and
the read performance adjustment module is configured to:
shift at least a part of data stored in areas corresponding to second memory IDs that are mapped to logical block IDs, which are included in the LRU list, to the third memory cluster, and
shift a part of data stored in areas corresponding to second memory IDs that are mapped to logical block IDs, which are not included in the LRU list, to the first memory cluster.

10. The system of claim 1, wherein the external computer is capable of transmitting and receiving data to and from at least one of a media stream server, a File Transfer Protocol (FTP) server, a Database Management System (DBMS) server, and a Virtual Machine File System (VMFS) server.
